(19) United States
(12) Patent Application Publication
(10) Pub. No.: US 2026/0072416 A1
(43) Pub. Date: Mar. 12, 2026

(54) FOSSIL FUEL PRODUCTION OPTIMIZATION

(71) Applicant: BP Corporation North America Inc., Houston, TX (US)

(72) Inventors: Gillian GOBY, Aberdeen (GB); Carlos Culane STEWART, Houston, TX (US); Shaun HOSEIN, Houston, TX (US); Diego UNZUETA RUEDAS, London (GB)

(73) Assignee: BP Corporation North America Inc., Houston, TX (US)

(21) Appl. No.: 19/325,783

(22) Filed: Sep. 11, 2025

Related U.S. Application Data
(60) Provisional application No. 63/693,603, filed on Sep. 11, 2024.

(51) Int. Cl. G05B 13/04

(52) U.S. Cl. CPC G05B 13/042

(57) ABSTRACT

Methods, systems, and apparatus, including computer programs encoded on a computer storage medium, for optimizing fossil fuel production capacity are disclosed. In one aspect, a method includes the actions of accessing a first scenario of a fossil fuel production field. The actions further include receiving a first amount to adjust a first constraint and a second amount to adjust a second constraint. The actions further include determining first Lagrange multipliers of the second constraint. The actions further include determining a first gradient of the first constraint. The actions further include determining whether adjusting the first constraint from the first value according to the first amount or adjusting the second constraint from the second value according to the second amount has a larger impact on fossil fuel production. The actions further include generating a second scenario of the fossil fuel production field.

### CROSS-REFERENCE TO RELATED APPLICATION

This application claims the benefit of U.S. provisional patent application Ser. No. 63/693,603 filed Sep. 11, 2024, and entitled “Production Optimization,” which is hereby incorporated by reference in its entirety for all purposes.

### STATEMENT REGARDING FEDERALLY SPONSORED RESEARCH OR DEVELOPMENT

Not applicable.

### BACKGROUND

Fossil fuel production encompasses the processes of locating, extracting, refining, and transporting coal, oil, and natural gas. These fuels, formed over millions of years from ancient organic matter, can be extracted and burnt to provide energy and/or generate heat. The production process varies based on the fuel type and geological conditions, including drilling, mining, and refining techniques.

### SUMMARY

An innovative aspect of the subject matter described in this specification may be implemented in a method for optimizing fossil fuel production. The method includes the action of accessing a first scenario of a fossil fuel production field, wherein the first scenario includes a first value of a first constraint, a second value of a second constraint, and a first fossil fuel production value. The method further includes the action of receiving a first amount to adjust the first constraint and a second amount to adjust the second constraint. The method further includes the action of determining first Lagrange multipliers of the second constraint based on the second value of the second constraint and the second amount to adjust the second constraint. The method further includes the action of determining a first gradient of the first constraint based on the first value of the first constraint and the first amount to adjust the first constraint. The method further includes the action of determining whether adjusting the first constraint from the first value according to the first amount or adjusting the second constraint from the second value according to the second amount has a larger impact on fossil fuel production from the fossil fuel production field based on the first gradient and the first Lagrange multipliers. The method further includes the action of generating a second scenario of the fossil fuel production field, wherein the second scenario includes a third value of the first constraint, a fourth value of the second constraint, and a second fossil fuel production value based on determining whether adjusting the first constraint or the second constraint has a larger impact on fossil fuel production from the fossil fuel production field.

Other implementations of this aspect include corresponding systems, apparatus, and computer programs recorded on computer storage devices, each configured to perform the operations of the method.

Embodiments described herein comprise a combination of features and characteristics intended to address various shortcomings associated with certain prior devices, systems, and methods. The foregoing has outlined rather broadly the features and technical characteristics of the disclosed embodiments in order that the detailed description that follows may be better understood. The various characteristics and features described above, as well as others, will be readily apparent to those skilled in the art upon reading the following detailed description, and by referring to the accompanying drawings. It should be appreciated that the conception and the specific embodiments disclosed may be readily utilized as a basis for modifying or designing other structures for carrying out the same purposes as the disclosed embodiments. It should also be realized that such equivalent constructions do not depart from the spirit and scope of the principles disclosed herein.

### BRIEF DESCRIPTION OF THE DRAWINGS

For a more complete understanding of the present disclosure, reference is now made to the following brief description, taken in connection with the accompanying drawings and detailed description, wherein like reference numerals represent like parts.

FIG. 1 illustrates an example system that is configured to optimize the production of a fossil fuel production facility in accordance with principles described herein.

FIG. 2 illustrates an example computing device that is configured to optimize the production of a fossil fuel production facility in accordance with principles described herein.

FIG. 3 is a flowchart of an example process for optimizing the production of a fossil fuel production facility in accordance with principles described herein.

### DETAILED DESCRIPTION

The following discussion is directed to various exemplary embodiments. However, one skilled in the art will understand that the examples disclosed herein have broad application, and that the discussion of any embodiment is meant only to be exemplary of that embodiment, and not intended to suggest that the scope of the disclosure, including the claims, is limited to that embodiment.

Certain terms are used throughout the following description and claims to refer to particular features or components. As one skilled in the art will appreciate, different persons may refer to the same feature or component by different names. This document does not intend to distinguish between components or features that differ in name but not function. The drawing figures are not necessarily to scale. Certain features and components herein may be shown exaggerated in scale or in somewhat schematic form and some details of conventional elements may not be shown in interest of clarity and conciseness.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.).

In the following discussion and in the claims, the terms “including” and “comprising” are used in an open-ended fashion, and thus should be interpreted to mean “including, but not limited to . . . .” Use of the term “optionally” with respect to any element of a claim is intended to mean that the subject element is required, or alternatively, is not required. Both alternatives are intended to be within the scope of the claim. The term “couple” or “couples” is intended to mean either an indirect or direct connection. As used herein, the terms “approximately,” “abut,” “substantially,” and the like mean within 10% (i.e., plus or minus 10%) of the recited value. Thus, for example, a recited angle of “about 80 degrees” refers to an angle ranging from 72 degrees to 88 degrees.

A production optimization platform and corresponding ontology enables critical workflows with the production of various fossil fuels. The first stage relates to monitoring and surveillance. In the first stage, the platform ensures the health of the production facilities, identifies and predicts potential production anomalies, and pre-empts failures. The second stage relates to various types of optimization. In the second stage, the platform identifies opportunities to maximize production within current system limits and constraints. The third stage relates to capacity growth. In the third stage, the platform identifies opportunities to safely grow the throughput of the production facilities beyond the current system limits and/or constraint values. The third stage may include the production optimizer. The platform may process data and output results in real-time.

The production optimizer may be an intelligent opportunity finder. The production optimizer is a digital capability that helps identify hydrocarbon production opportunities by testing the impact of relaxing system constraints. The production optimizer does this autonomously, allowing for more frequent testing than previously possible. The production optimizer learns what constraints have the most impact on hydrocarbon production from hydraulic simulations. The hydraulic simulations may be performed by an optimization run using the second stage. The production optimizer makes use of run time parameters, such as Lagrange multipliers and gradients, that are calculated by the simulator. The production optimizer then relaxes the most impactful constraint by a user-defined percentage and re-runs the simulation. The production optimizer process may repeat. Each time, the production optimizer identifies and relaxes the most impactful constraint, generating a user-defined number of production enhancement scenarios.

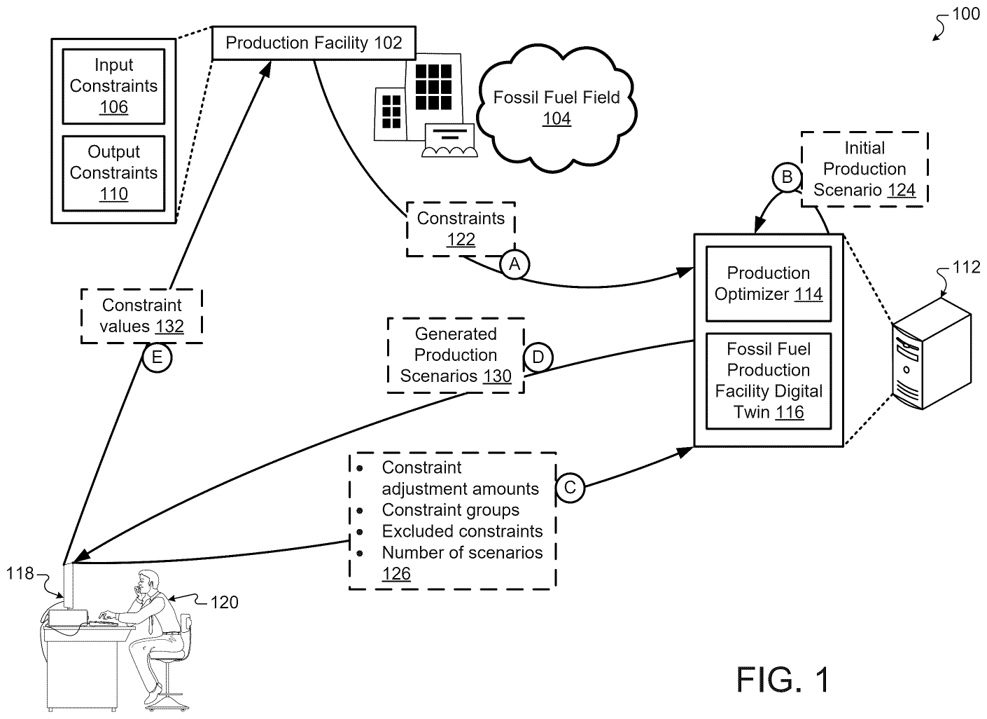

FIG. 1 illustrates an example system 100 that is configured to optimize the production of a fossil fuel or hydrocarbon production facility 102. Briefly, and as described in more detail below, fossil fuel production facility 102 may be configured to extract a fossil fuel from the fossil fuel field 104. The fossil fuel production facility 102 may have various input constraints 106 and output constraints 110. The computing device 112 may execute a production optimizer 114 that is configured to relax various constraints of the input constraints 106 and output constraints 110 and simulate the fossil fuel production of the fossil fuel production facility 102 utilizing the fossil fuel production facility digital twin 116. The production optimizer 114 may perform this simulation a number of times and generate a number of different scenarios for the fossil fuel production facility 102. The different scenarios may include different values for the input constraints 106 and output constraints 110. These different values may result changes in the fossil fuel production of the fossil fuel production facility 102. The user 120 may evaluate the different scenarios and decide to implement one of them in the fossil fuel production facility 102. FIG. 1 includes various stages A through E that may illustrate the performance of actions and/or the movement of data between various components of the computing device 112, the computing device 118, a computing device of the production facility 102, and/or any other computing devices. The system 100 may perform these stages in any order.

In more detail, the fossil fuel field 104 may be an oil field, natural gas field, and/or any other type of fossil fuel that is located underground. The fossil fuel field 104 may include one or more wells. The fossil fuel production facility 102 may include various pumps, tanks, valves, pipes, etc. that connect to the one or more wells of the fossil fuel field 104. The fossil fuel production facility 102 may have various input constraints 106 and output constraints 110. The input constraints 106 may be related to settings of various valves and/or chokes, the power provided to various pumps, pressure settings, and/or any other similar setting. The output constraints 110 may relate to settings of elements related to the output of the fossil fuel production facility 102. For example, the output constraints 110 may include rates, pressures, temperatures, velocities, and/or any other similar derived output. The input constraints 106 and output constraints 110 may be unique to the fossil fuel production facility 102 and/or may be similar to input and output constraints of another fossil fuel production facility. The computing device 112 may execute a fossil fuel production facility digital twin 116. The fossil fuel production facility digital twin 116 may be configured to simulate the fossil fuel production facility 102 and the fossil fuel field 104. The fossil fuel production facility digital twin 116 may be configured to predict the likely fossil fuel production of the fossil fuel production facility 102 and the fossil fuel field 104 given a particular set of values for the input constraints 106 and output constraints 110, in addition to any other relevant parameters.

The user 120 may be attempting to increase the fossil fuel production of the fossil fuel production facility 102. The user 120 may have access to the input constraints 106 and output constraints 110 and may have the ability to adjust one or more of the input constraints 106 and output constraints 110. The user 120 may not know the proper manner or amounts to adjust the input constraints 106 and/or output constraints 110 in order to increase the fossil fuel production of the fossil fuel production facility 102. Additionally, adjusting some of the input constraints 106 and/or output constraints 110 may be a multistep and/or time-consuming process. It is beneficial to know the proper input constraints 106 and/or output constraints 110 in order to increase production before actually adjusting the input constraints 106 and/or output constraints 110.

The user 120 may be interacting with the computing device 118. The computing device 118 may be any type of computing device that is configured to communicate with other computing devices. For example, the computing device 118 may be a server, desktop computer, laptop computer, tablet, phone, smart device, and/or any other similar type of device. The computing device 118 may communicate with computing devices of the fossil fuel production facility 102 and with the computing device 112. The computing device 112 may execute a production optimizer 114 that is configured to identify adjustments to the input constraints 106 and/or output constraints 110 in order to increase production. The user 120 may interact with the computing device 112 and initiate the process to determine how to adjust the input constraints 106 and/or output constraints 110 in order to increase production of the fossil fuel production facility 102.

In stage A, the production optimizer 114 may communicate with fossil fuel production facility 102. The production optimizer 114 may request data identifying the input constraints 106 and output constraints 110 of the fossil fuel production facility 102. In response to that request, a computing device of the fossil fuel production facility 102 may generate a constraints packet 122. The constraints packet 122 may include data identifying the input constraints 106 and output constraints 110 of the fossil fuel production facility 102. The constraints packet 122 may include the current value of each of the input constraints 106 and output constraints 110. The constraints packet 122 may also include any practical and/or theoretical minimums and/or maximums of the input constraints 106 and output constraints 110. The constraints packet 122 may also include data identifying the adjustment increments of the input constraints 106 and output constraints 110. The constraints packet 122 may also include the current fossil fuel production of the fossil fuel production facility 102. The constraints packet 122 may also include any historical data related to the previous values of the input constraints 106 and output constraints 110 in addition to the corresponding fossil fuel production of the fossil fuel production facility 102.

In stage B, the production optimizer 114 generates an initial production scenario 124. The initial production scenario 124 may be the current settings of the input constraints 106 and output constraints 110. In some implementations, the initial production scenario 124 may be an average setting of the input constraints 106 and output constraints 110 over a period of time. In some implementations, the initial production scenario 124 may be an arbitrary setting of the input constraints 106 and output constraints 110. For example, the user 120 may provide the initial production scenario 124. As another example, the initial production scenario 124 may be the last settings of the input constraints 106 and output constraints 110 used by the production optimizer 114 during a previous optimization request.

The computing device 112 may execute the production optimizer 114. The computing device 112 may be any type of computing device that is configured to communicate with other computing devices. For example, the computing device 118 may be a server, desktop computer, laptop computer, tablet, phone, smart device, and/or any other similar type of device. As noted above, the computing device 112 may also execute the fossil fuel production facility digital twin 116.

In stage C, the user 120 may provide various settings and instructions to the production optimizer 114. The settings and instructions may be included in an instruction packet 126. The production optimizer 114 may use the settings and instructions to perform the production optimization process to determine possible adjustments to the input constraints 106 and output constraints 110 to improve the fossil fuel production of the fossil fuel production facility 102. The instruction packet 126 may include amount to adjust one or more of the input constraints 106 and output constraints 110. The adjustment amounts may be different for each of the input constraints 106 and output constraints 110. In some implementations, the adjustment amounts may indicate a range, a percentage, and/or an amount to adjust the constraint. In some implementations, the adjustment amounts may not include a range, a percentage, and/or an amount to adjust the constraint. Instead, the adjustment amounts may indicate to relax, or adjust, the constraint. This instruction may allow the production optimizer 114 to adjust a constraint within the physical and/or theoretical limits.

The instruction packet 126 may include constraint groups. The constraint groups may indicate which of the input constraints 106 and output constraints 110 to group and adjust together. For example, a constraint related to a choke and a constraint related to pressure may be grouped. Grouped constraints may be adjusted by a similar percentage or absolute amount during some iterations of the optimization process. Grouped constrained may remain unadjusted during some iterations of the optimization process. Grouped constraints may include two or more constraints.

The instruction packet 126 may include excluded constraints. The excluded constraints may be those constraints that are not adjusted, or relaxed during the iterations of the optimization process. The excluded constraints may include one or more of the input constraints 106 and output constraints 110.

The instruction packet 126 may include a number of scenarios for the production optimizer 114 to generate. The number of scenarios may be the number of iterations of the optimization process. More scenarios may result in scenarios that may indicate higher likelihood of production increase of the production facility 102. Fewer scenarios may result in scenarios that do not indicate as high increases in likelihood of production increase of the production facility 102. More scenarios may use more computing resources of the computing device 112. At some point, specifying more scenarios may not generate scenarios with meaningful increases in likelihood of production increase of the production facility 102.

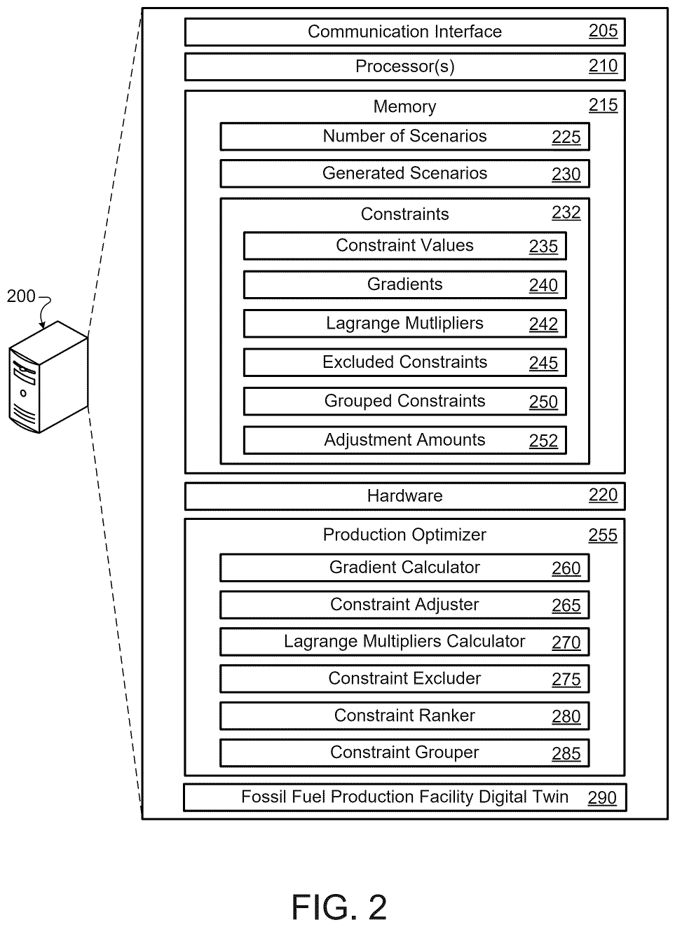

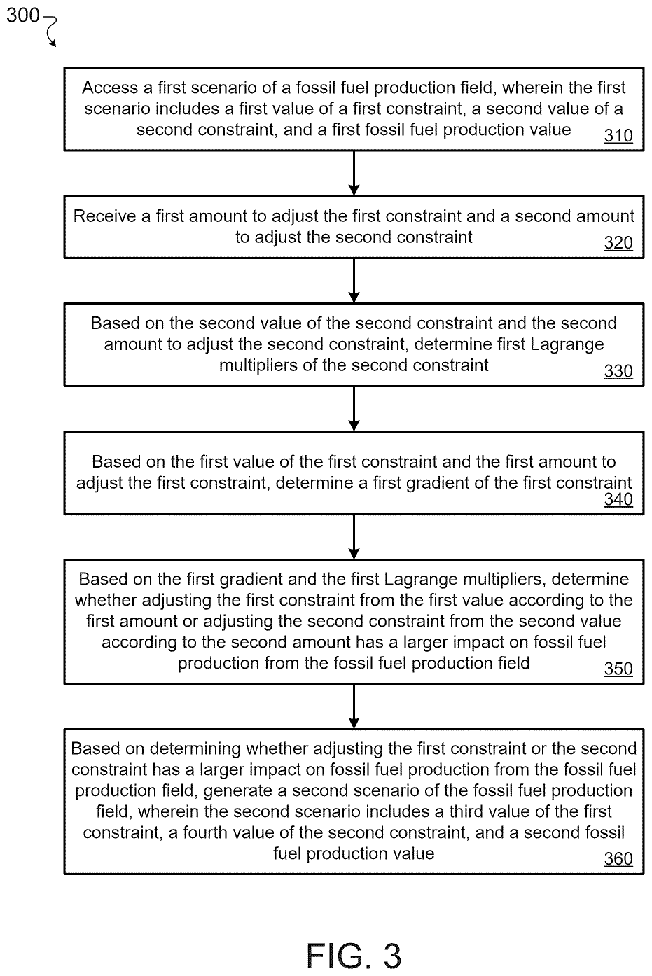

In stage D, the production optimizer 114 may execute the optimization process. The optimization process and the components of the production optimizer 114 may be discussed in more detail below with respect to FIGS. 2 and 3. In short, the production optimizer 114 may begin the optimization process with the constraints set at the values specified by the initial production scenario 124. The production optimizer 114 may exclude the constraints and group the constraints as specified in the instruction packet 126.

During the first iteration, the production optimizer 114 may calculate Lagrange multipliers for the output constraints. In some implementations, the production optimizer 114 may calculate one or more Lagrange multipliers. The production optimizer 114 may rank the Lagrange multipliers, with the highest value constraints being the constraints with the highest Lagrange multipliers. The highest value constraints may be those that, when adjusted, have the largest impact on increasing the fossil fuel production of the production facility 102.

Continuing with the first iteration, the production optimizer 114 may calculate gradients for the input constraints. In some implementations, the production optimizer 114 may calculate one or more gradient. The production optimizer 114 may rank the gradients, with the highest value constraints being the constraints with the highest gradients. The highest value constraints may be those that, when adjusted, have the largest impact on increasing the fossil fuel production of the production facility 102.

Continuing with the first iteration, the production optimizer 114 may adjust the highest value constraints as identified by the Lagrange multipliers and the gradients according to the constraint adjustment amounts specified in the instruction packet 126. The production optimizer 114 may utilize the fossil fuel production facility digital twin 116 to determine the predicted changes in the production by providing the adjusted constraints to the fossil fuel production facility digital twin 116. The result of the simulation may be the output of the first scenario.

The production optimizer 114 may initiate anew iteration and may continue looping until the number of scenarios specified in the instruction packet 126 is reached. The constraint values to begin the new iteration may be those provided to the fossil fuel production facility digital twin 116 during the current iteration. The results of each simulation may be included in the generated production scenarios packet 130.

The generated production scenarios packet 130 may include the values of the input constraints 106 and output constraints 110 from each scenario. The generated production scenarios packet 130 may also include the likely fossil fuel production of the production facility 102. The computing device 112 may provide the generated production scenarios packet 130 to the computing device 118.

In stage E, the user 120 may evaluate the values of the input constraints 106 and output constraints 110 from each scenario included in the production scenarios packet 130. The user 120 may select one of the scenarios to implement. In some implementations, the user 120 may not select the scenario with the highest likely fossil fuel production. This may be because a scenario may include values for a constraint that may require an evaluation to determine whether the constraint value is likely to cause any problems with the production facility 102 and/or the fossil fuel field 104. Those constraint values may require an engineering study to determine whether the constraint value is likely to cause any problems. The user 120 selects a scenario from the production scenarios packet 130. The computing device 118 generated a constraints value packet 132 that includes the constraint values from the selected scenario. The production facility 102 receives the constraints value packet 132 and implements the constraint values. Once implemented, the fossil fuel production of the fossil fuel production facility 102 and the fossil fuel field 104 will likely increase.

FIG. 2 illustrates an example computing device 200 that is configured to optimize the production of a fossil fuel production facility. The device 200 may be any type of computing device that is configured to communicate with other computing devices. The device 200 may communicate with other computing devices using a wide area network, a local area network, the internet, a wired connection, a wireless connection, and/or any other type of network or connection. The wireless connections may include Wi-Fi, short-range radio, infrared, and/or any other wireless connection. The device 200 may be similar to the computing device 112 of FIG. 1. Some of the components of the device may be implemented in a single computing device or distributed over multiple computing devices. Some of the components may be in the form of virtual machines or software containers that are hosted in a cloud in communication with disaggregated storage devices.

The device 200 may include a communication interface 205, one or more processors 210, memory 215, and hardware 220. The communication interface 205 may include communication components that enable the server 200 to transmit data and receive data from devices connected to the wireless carrier network. The communication interface 205 may include an interface that is configured to communicate with base stations of a wireless carrier network. The communication interface 205 may receive data that other devices transmit to the base stations and/or transmit data to the base stations for transmission to the other devices. In some implementations, the communication interface 205 may be configured to communicate over a wide area network, a local area network, the internet, a wired connection, a wireless connection, and/or any other type of network or connection. The wireless connections may include Wi-Fi, short-range radio, infrared, and/or any other wireless connection.

The hardware 220 may include user interface, data communication, or data storage hardware. For example, the user interfaces may include a data output device (e.g., visual display, audio speakers), and one or more data input devices. The data input devices may include, but are not limited to, combinations of one or more of keypads, keyboards, mouse devices, touch screens that accept gestures, microphones, voice or speech recognition devices, and any other suitable devices.

The memory 215 may be implemented using computer-readable media, such as computer storage media. Computer-readable media includes, at least, two types of computer-readable media, namely computer storage media and communications media. Computer storage media includes volatile and non-volatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. In some implementations, the data stored in the memory 215 may be stored externally from the device 200.

The one or more processors 210 may implement, through the execution of computer-executable instructions stored in the memory 215, a production optimizer 255. The production optimizer 255 may be similar to the production optimizer 114 of FIG. 1. The production optimizer 255 may be configured to analyze the constraints of a fossil fuel production facility and/or a fossil fuel field and identify values for the constraints that are likely to increase fossil fuel production from the fossil fuel production facility and/or a fossil fuel field. The production optimizer 255 may have various components such as the gradient calculator 260, the constraint adjuster 265, the Lagrange multipliers calculator 270, the constraint excluder 275, the constraint ranker 280, and the constraint grouper 285. Each of these components will be described in more detail below.

The one or more processors 210 may implement, through the execution of computer-executable instructions stored in the memory 215, a fossil fuel production facility digital twin 290. The fossil fuel production facility digital twin 290 may be configured to simulate an actual fossil fuel production facility and/or a fossil fuel field. The fossil fuel production facility digital twin 290 may receive values for the various constraints of the fossil fuel production facility and/or a fossil fuel field and output a likely fossil fuel production of the fossil fuel production facility and/or a fossil fuel field.

The memory 215 may store various data related to the fossil fuel production facility, the fossil fuel field, the production optimizer 255, and/or the fossil fuel production facility digital twin 290. The memory 215 may store a number of scenarios 225 to execute, the generated scenarios 230, and the constraints 232. The constraints 232 may include various pieces of data including constant values 235, gradients 240, Lagrange multipliers 242, excluded constraints 245, grouped constraints 250, and adjustment amounts 252. Each of the types of data stored in the memory 215 will be discussed in more detail below.

The constraint grouper 285 may be configured to group constraints of the fossil fuel production facility and/or a fossil fuel field. The constraint grouper 285 may store data identifying the grouped constraints in the grouped constraints 250. The constraint grouper 285 may receive data from a user. The data may indicate which of the constraints of the fossil fuel production facility and/or a fossil fuel field to adjust together during the optimization process. Two or more constraints may be grouped. In some implementations, input constraints may be grouped with input constraints and output constraints may be grouped with output constraints. In some implementations, input constraints and output constraints may be grouped together.

The constraint excluder 275 may be configured to exclude constraints of the fossil fuel production facility and/or a fossil fuel field. The constraint excluder 275 may store data identifying the excluded constraints in the excluded constraints 245. The constraint excluder 275 may receive data from a user. The data may indicate with of the constraints of the fossil fuel production facility and/or a fossil fuel field to exclude from the optimization process. An excluded constraint may be one that does not change during the optimization process.

The Lagrange multipliers calculator 270 may be configured to compute the Lagrange multipliers of the various output constraints of the fossil fuel production facility and/or a fossil fuel field. The Lagrange multipliers calculator 270 may store the Lagrange multipliers in the Lagrange multipliers 242. The Lagrange multipliers calculator 270 may calculate Lagrange multipliers for each of the output constraints during each loop through the optimization process. In some implementations, the Lagrange multipliers calculator 270 may use the current value of the constraint, the current value of one or more other constraints, the adjustment amount of the constraint, and/or the adjustment amount of one or more other constraints. The adjustment amount of a constraint may specify the maximum and/or minimum of the constraint and/or the adjustment increment. In some implementations, the Lagrange multipliers calculator 270 may bypass calculating Lagrange multipliers for excluded output constraints.

The gradient calculator 260 may be configured to compute the gradients of the various input constraints of the fossil fuel production facility and/or a fossil fuel field. The gradient calculator 260 may store the gradients in the gradients 240. The gradient calculator 260 may calculate a gradient for each of the input constraints during each loop through the optimization process. In some implementations, the gradient calculator 260 may use the current value of the constraint, the current value of one or more other constraints, the adjustment amount of the constraint, and/or the adjustment amount of one or more other constraints. The adjustment amount of a constraint may specify the maximum and/or minimum of the constraint and/or the adjustment increment. In some implementations, the gradient calculator 260 may bypass calculating a gradient for excluded input constraints.

The constraint ranker 280 may be configured to rank the constraints based on the Lagrange multipliers 242 and/or the gradients 240. The constraint ranker 280 may compare the previously calculated Lagrange multipliers 242. The constraint ranker 280 may rank the Lagrange multipliers 242 from highest to lowest. Based on this ranking, the constraint ranker 280 may rank the corresponding constraint values 235 from largest to smallest impact on the output of fossil fuel production facility and/or a fossil fuel field. The constraint ranker may rank the gradients 240 from highest to lowest. Based on this ranking, the constraint ranker 280 may rank the corresponding constraint values 235 from largest to smallest impact on the output of fossil fuel production facility and/or a fossil fuel field.

The constraint adjuster 265 may be configured to adjust the constraints identified by the constraint ranker 280 as having the largest impact on the output of fossil fuel production facility and/or a fossil fuel field. The constraint adjuster 265 may adjust these constraints according to the adjustment amounts 252. The adjustment amounts 252 may indicate a range and/or increments to adjust the constraints. The constraint adjuster 265 may adjust the constraints and provide the adjusted constraints to the fossil fuel production facility digital twin 290.

The fossil fuel production facility digital twin 290 may process the constraints, including the adjusted constraints, and generate an output indicating a likely fossil fuel production of the fossil fuel production facility and/or a fossil fuel field. The fossil fuel production facility digital twin 290 may provide the output to the production optimizer 255. The production optimizer 255 may store the constraints provided to the fossil fuel production facility digital twin 290 and the likely fossil fuel production of the fossil fuel production facility and/or a fossil fuel field in the generated scenarios 230. The production optimizer 255 may repeat the process of calculating Lagrange multipliers, gradients, and likely fossil fuel production to generate additional scenarios. The production optimizer 255 may repeat this process as many times as specified in the number of scenarios 225. A user may evaluate the generated scenarios 230 and determine which one to implement in the fossil fuel production facility 102 and/or a fossil fuel field 104.

FIG. 3 is a flowchart of an example process 300 for optimizing the production of a fossil fuel production facility 102. The process 300 accesses a scenario for a fossil fuel production facility 102. The scenario may include various settings for the various constraints of the fossil fuel production facility 102. The process 300 receives amounts to adjust the constraints. The process 300 determines a gradient or Lagrange multipliers for each constraint. Based on the gradients and the Lagrange multipliers, the process 300 determines which constraints have the highest impact on the fossil fuel production of the fossil fuel production facility 102. The process 300 relaxes those constraints and determines a likely fossil fuel production of the fossil fuel production facility 102 with the adjusted constraints. The process 300 repeats with the new adjusted constraints as the starting point for the process 300. The process 300 may repeat as many times as requested by a user. The process 300 will be described as being performed by the computing device 112 and will include references to other components in FIG. 1. In some implementations, the process 300 may be performed by the device 200 of FIG. 2. The process 300 may be performed by a single computing device, which may be a virtual device and/or split across multiple computing devices that may include virtual devices. In some implementations, the process 300 may be performed by an application that is running on the computing device 112. For example, the application may be the production optimizer 114.

The computing device 112 accesses a first scenario of a fossil fuel production field, wherein the first scenario includes a first value of a first constraint, a second value of a second constraint, and a first fossil fuel production value (310). In some implementations, the first constraint is an input constraint of the fossil fuel production facility and/or fossil fuel production field. In some implementations, the second constraint is an output constraint of the fossil fuel production facility and/or fossil fuel production field.

In some implementations, the first scenario may include a third value of a third constraint, a fourth value of a fourth constraint, a fifth value of a fifth constraint, and/or a sixth value of a sixth constraint. In some implementations, there may be additional values of additional constraints depending on the fossil fuel production facility and/or fossil fuel production field. In some implementations, fossil fuel production facility and/or fossil fuel production field may include additional constraints. The additional constraints may each have an associated value. In some implementations, the first scenario may indicate the current values of the constraints of the fossil fuel production facility and/or fossil fuel production field.

The computing device 112 receives a first amount to adjust the first constraint and a second amount to adjust the second constraint (320). In some implementations, the computing device 112 may receive amounts to adjust additional constraints such as the third constraint and/or the fourth constraint. In some implementations, the computing device 112 may receive instructions to bypass adjusting, or exclude, a constraint. This request may remove the bypassed, or excluded constraint from analysis. In some implementations, the computing device 112 may receive instructions to group constraints. The grouping instructions may indicate to adjust two or more constraints by a same percentage or actual amount or maintain the values of the grouped constraints. In other words, during analysis, the computing device 112 may not change, or relax, only one of constraint of grouped constraints. The computing device 112 should change the grouped constraints in a group.

Based on the second value of the second constraint, the second amount to adjust the second constraint, and/or other constraints, the computing device 112 determines first Lagrange multipliers of the second constraint (330). In some implementations, the computing device 112 may determine Lagrange multipliers for all of the output constraints. For example, the computing device 112 may determine Lagrange multipliers for the second, fourth, and sixth constraints, which are the output constraints. In some implementations, the computing device 112 may determine the Lagrange multipliers for all of the output constraints except for the excluded constraints.

Based on the first value of the first constraint, the first amount to adjust the first constraint, and/or other constraints, the computing device 112 determines a first gradient of the first constraint (340). In some implementations, the computing device 112 may determine a gradient for all of the input constraints. For example, the computing device 112 may determine a gradient for the first, third, and fifth constraints, which are the input constraints. In some implementations, the computing device 112 may determine the gradients for all of the input constraints except for the excluded constraints.

Based on the first gradient and the first Lagrange multiplier, the computing device 112 determines whether adjusting the first constraint from the first value according to the first amount or adjusting the second constraint from the second value according to the second amount has a larger impact on fossil fuel production from the fossil fuel production field (350). In other words, the computing device 112 may determine the high value constraints. The computing device 112 may compare the gradients of the input constraints to each other. The highest gradient may indicate that the input constraint may have the largest impact on the fossil fuel production from the fossil fuel production field. The computing device 112 may compare the Lagrange multipliers to each other. The computing device 112 may compare the gradients of the input constraints to each other. The highest gradient may indicate that the input constraint may have the largest impact on the fossil fuel production from the fossil fuel production field 104. In some implementations, a constraint may be disregarded or excluded. In this case, computing device 112 may not compare the gradient or Lagrange multipliers to the other gradients or Lagrange multipliers. In some implementations, one or more constraints may be grouped. In this case, the computing device 112 may identify one or more grouped constraints as the most impactful if one of the gradients or Lagrange multipliers of the one or more grouped constraints is highest.

Based on determining whether adjusting the first constraint or the second constraint has a larger impact on fossil fuel production from the fossil fuel production field, the computing device 112 generates a second scenario of the fossil fuel production field. The second scenario includes a third value of the first constraint, a fourth value of the second constraint, and a second fossil fuel production value (360). The computing device 112 may utilize a fossil fuel production facility digital twin 116 to simulate the output of the fossil fuel production facility and/or the fossil fuel production field. The computing device 112 may generate the second scenario by adjusting the one or more constraints with the highest gradient or Lagrange multiplier. The computing device 112 may adjust the one or more constraints according to the received adjustment amounts or ranges. The computing device 112 may provide various sets of inputs to the fossil fuel production facility digital twin 116. The inputs may include constraint values similar to the first scenario but with the one or more constraints with the highest gradient or Lagrange multipliers changed according to the received adjustment amounts or ranges. For example, with a constraint with a value of ten and a range of plus or minus five and an increment of one, the computing device 112 may provide various sets of inputs that include the constraint with a value of five, six, seven, eight, nine, eleven, twelve, thirteen, fourteen, and fifteen. The computing device 112 may determine which set of constraints results in a high increase in the fossil fuel production of the fossil fuel production field according to the output of the fossil fuel production facility digital twin 116.

The computing device 112 may output a scenario that may specify the various values of the constraints. The scenario may be similar to the first scenario with the exception of the updated constraint. The updated constraint may have the value that resulted in the highest increase in the fossil fuel production of the fossil fuel production field according to the output of the fossil fuel production facility digital twin 116. The computing device 112 may repeat the process 300 with the new scenario as the input. The computing device 112 may repeat the process as many times as requested by the user.

In some implementations, the computing device 112 may adjust the highest input and output constraints in tandem. The computing device 112 adjusts both the input and output constraints with the highest gradient and Lagrange multiplier, respectively. The computing device 112 may provide the constraint values and the adjusted pair of constraint values to the fossil fuel production facility digital twin 116. The computing device 112 may provide various sets of inputs to and receive various sets of outputs from the fossil fuel production facility digital twin 116. Each set may have a different value for the adjusted pair constraint values. If the adjusted input constraint can have five different values, and the adjusted output constraint can have four different values, then the computing device 112 may provide twenty different sets of constraints to the fossil fuel production facility digital twin 116. The selected scenario may be the set of constraints that generates the highest production by the fossil fuel production facility digital twin 116.

The computing device 112 may output all the scenarios generated during each iteration of the process 300. The computing device 112 may rank them according to the highest production as indicated by the fossil fuel production facility digital twin 116. The user 120 may evaluate each of the scenarios and determine which one to implement. The user 120 may provide the constraint values from the selected scenario to the fossil fuel production facility 102. In some implementations, the computing device 112 may automatically provide the constraint values from the scenario with the highest production as indicated by the fossil fuel production facility digital twin 116 to the fossil fuel production facility 102. The fossil fuel production facility 102 may update the constraint values, which should result in an increase in fossil fuel production.

While several implementations have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted or not implemented. Accordingly, the scope of protection is not limited to the embodiments described herein, but is only limited by the claims that follow, the scope of which shall include all equivalents of the subject matter of the claims. Unless expressly stated otherwise, the steps in a method claim may be performed in any order. The recitation of identifiers such as (a), (b), (c) or (1), (2), (3) before steps in a method claim are not intended to and do not specify a particular order to the steps, but rather are used to simplify subsequent reference to such steps.

Also, techniques, systems, subsystems, and methods described and illustrated in the various implementations as discrete or separate may be combined or integrated with other systems, modules, techniques, or methods without departing from the scope of the present disclosure. Other items shown or discussed as directly coupled or communicating with each other may be indirectly coupled or communicating through some interface, device, or intermediate component, whether electrically, mechanically, or otherwise. Other examples of changes, substitutions, and alterations are ascertainable by one skilled in the art and could be made without departing from the spirit and scope disclosed herein.

Each and every claim is incorporated into the specification as an aspect of the present disclosure. Thus, the claims are a further description and are an addition to the aspects of embodiments disclosed herein. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

What is claimed is:

1. A computer-implemented method comprising:
accessing a first scenario of a fossil fuel production field, wherein the first scenario includes a first value of a first constraint, a second value of a second constraint, and a first fossil fuel production value;
receiving a first amount to adjust the first constraint and a second amount to adjust the second constraint;
based on the second value of the second constraint and the second amount to adjust the second constraint, determining first Lagrange multipliers of the second constraint;
based on the first value of the first constraint and the first amount to adjust the first constraint, determining a first gradient of the first constraint;
based on the first gradient and the first Lagrange multipliers, determining whether adjusting the first constraint from the first value according to the first amount or adjusting the second constraint from the second value according to the second amount has a larger impact on fossil fuel production from the fossil fuel production field; and
based on determining whether adjusting the first constraint or the second constraint has a larger impact on fossil fuel production from the fossil fuel production field, generating a second scenario of the fossil fuel production field, wherein the second scenario includes a third value of the first constraint, a fourth value of the second constraint, and a second fossil fuel production value.

2. The method of claim 1, wherein the first constraint is an input constraint of the fossil fuel production field.

3. The method of claim 1, wherein the second constraint is an output constraint of the fossil fuel production field.

4. The method of claim 1, comprising:
receiving data indicating to generate two scenarios of the fossil fuel production field;
based on the fourth value of the second constraint and second amount to adjust the second constraint, determining second Lagrange multipliers of the second constraint;
based on the third value of the first constraint and the first amount to adjust the first constraint, determining a second gradient of the first constraint;
based on the second gradient and the second Lagrange multipliers, determining whether adjusting the first constraint from the third value according to the first amount or adjusting the second constraint from the fourth value according to the second amount has a larger impact on fossil fuel production from the fossil fuel production field;
based on determining whether adjusting the first constraint or the second constraint has a larger impact on fossil fuel production from the fossil fuel production field, generating a third scenario of the fossil fuel production field, wherein the third scenario includes a fifth value of the first constraint, a sixth value of the second constraint, and third fossil fuel production value.

5. The method of claim 4, comprising:
ranking the second scenario and the third scenario based on the second fossil fuel production value and the third fossil fuel production value.

6. The method of claim 1, wherein the first scenario further includes a fifth value of a third constraint, and the method further comprises:
receiving data indicating to group the first constraint and the third constraint;
receiving a third amount to adjust the third constraint; and
based on the fifth value of the third constraint and the third amount to adjust the third constraint, determining a second gradient or Lagrange multipliers of the third constraint,
wherein determining whether adjusting the first constraint from the first value according to the first amount or adjusting the second constraint from the second value according to the second amount has a larger impact on fossil fuel production from the fossil fuel production field comprises:
based on the first gradient, the first Lagrange multiplier, the second gradient or Lagrange multipliers, and the data indicating to group the first constraint and the third constraint, determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, and
wherein generating the second scenario of the fossil fuel production field comprises:
based on determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, generating the second scenario of the fossil fuel production field, wherein the second scenario includes the third value of the first constraint, the fourth value of the second constraint, a fifth value of the third constraint, and the second fossil fuel production value.

7. The method of claim 1, wherein the first scenario further includes a fifth value of a third constraint, and the method further comprises:
receiving data indicating to bypass adjusting the third constraint.

8. The method of claim 1, wherein the first scenario further includes a fifth value of a third constraint and a sixth value of a fourth constraint, and the method further comprises:
receiving a third amount to adjust the third constraint and a fourth amount to adjust the fourth constraint;
based on the sixth value of the fourth constraint and fourth amount to adjust the fourth constraint, determining second Lagrange multipliers of the third constraint;
based on the fifth value of the third constraint and the third amount to adjust the third constraint, determining a second gradient of the third constraint;
comparing the first gradient to the second gradient; and
comparing the first Lagrange multipliers to the second Lagrange multiplier,
wherein determining whether adjusting the first constraint from the first value according to the first amount or adjusting the second constraint from the second value according to the second amount has a larger impact on fossil fuel production from the fossil fuel production field is based further on comparing the first gradient to the second gradient and comparing the first Lagrange multipliers to the second Lagrange multipliers.

9. A system, comprising:
one or more processors; and
memory including a plurality of computer-executable components that are executable by the one or more processors to perform acts comprising:
accessing a first scenario of a fossil fuel production field, wherein the first scenario includes a first value of a first constraint, a second value of a second constraint, and a first fossil fuel production value;
receiving a first amount to adjust the first constraint and a second amount to adjust the second constraint;
based on the second value of the second constraint and the second amount to adjust the second constraint, determining first Lagrange multipliers of the second constraint;
based on the first value of the first constraint and the first amount to adjust the first constraint, determining a first gradient of the first constraint;
based on the first gradient and the first Lagrange multipliers, determining whether adjusting the first constraint from the first value according to the first amount or adjusting the second constraint from the second value according to the second amount has a larger impact on fossil fuel production from the fossil fuel production field; and
based on determining whether adjusting the first constraint or the second constraint has a larger impact on fossil fuel production from the fossil fuel production field, generating a second scenario of the fossil fuel production field, wherein the second scenario includes a third value of the first constraint, a fourth value of the second constraint, and a second fossil fuel production value.

10. The system of claim 9, wherein the first constraint is an input constraint of the fossil fuel production field.

11. The system of claim 9, wherein the second constraint is an output constraint of the fossil fuel production field.

12. The system of claim 9, wherein the acts comprise:
receiving data indicating to generate two scenarios of the fossil fuel production field;
based on the fourth value of the second constraint and second amount to adjust the second constraint, determining second Lagrange multipliers of the second constraint;
based on the third value of the first constraint and the first amount to adjust the first constraint, determining a second gradient of the first constraint;
based on the second gradient and the second Lagrange multipliers, determining whether adjusting the first constraint from the third value according to the first amount or adjusting the second constraint from the fourth value according to the second amount has a larger impact on fossil fuel production from the fossil fuel production field;
based on determining whether adjusting the first constraint or the second constraint has a larger impact on fossil fuel production from the fossil fuel production field, generating a third scenario of the fossil fuel production field, wherein the third scenario includes a fifth value of the first constraint, a sixth value of the second constraint, and third fossil fuel production value.

13. The system of claim 12, wherein the acts comprise:
ranking the second scenario and the third scenario based on the second fossil fuel production value and the third fossil fuel production value.

14. The system of claim 9, wherein the first scenario further includes a fifth value of a third constraint, and the acts further comprise:
receiving data indicating to group the first constraint and the third constraint;
receiving a third amount to adjust the third constraint; and
based on the fifth value of the third constraint and the third amount to adjust the third constraint, determining a second gradient or Lagrange multipliers of the third constraint,
wherein determining whether adjusting the first constraint from the first value according to the first amount or adjusting the second constraint from the second value according to the second amount has a larger impact on fossil fuel production from the fossil fuel production field comprises:
based on the first gradient, the first Lagrange multiplier, the second gradient or Lagrange multiplier, and the data indicating to group the first constraint and the third constraint, determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, and
wherein generating the second scenario of the fossil fuel production field comprises:
based on determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, generating the second scenario of the fossil fuel production field, wherein the second scenario includes the third value of the first constraint, the fourth value of the second constraint, a fifth value of the third constraint, and the second fossil fuel production value.

15. The system of claim 9, wherein the first scenario further includes a fifth value of a third constraint, and the acts further comprise:
receiving data indicating to bypass adjusting the third constraint.

16. The system of claim 9, wherein the first scenario further includes a fifth value of a third constraint and a sixth value of a fourth constraint, and the acts further comprise:
receiving a third amount to adjust the third constraint and a fourth amount to adjust the fourth constraint;
based on the sixth value of the fourth constraint and fourth amount to adjust the fourth constraint, determining second Lagrange multipliers of the third constraint;
based on the fifth value of the third constraint and the third amount to adjust the third constraint, determining a second gradient of the third constraint;
comparing the first gradient to the second gradient; and
comparing the first Lagrange multipliers to the second Lagrange multiplier,
wherein determining whether adjusting the first constraint from the first value according to the first amount or adjusting the second constraint from the second value according to the second amount has a larger impact on fossil fuel production from the fossil fuel production field is based further on comparing the first gradient to the second gradient and comparing the first Lagrange multipliers to the second Lagrange multiplier.

17. One or more non-transitory computer-readable media storing computer-executable instructions that upon execution cause one or more processors to perform acts comprising:
accessing a first scenario of a fossil fuel production field, wherein the first scenario includes a first value of a first constraint, a second value of a second constraint, and a first fossil fuel production value;
receiving a first amount to adjust the first constraint and a second amount to adjust the second constraint;
based on the second value of the second constraint and the second amount to adjust the second constraint, determining first Lagrange multipliers of the second constraint;
based on the first value of the first constraint and the first amount to adjust the first constraint, determining a first gradient of the first constraint;
based on the first gradient and the first Lagrange multiplier, determining whether adjusting the first constraint from the first value according to the first amount or adjusting the second constraint from the second value according to the second amount has a larger impact on fossil fuel production from the fossil fuel production field; and
based on determining whether adjusting the first constraint or the second constraint has a larger impact on fossil fuel production from the fossil fuel production field, generating a second scenario of the fossil fuel production field, wherein the second scenario includes a third value of the first constraint, a fourth value of the second constraint, and a second fossil fuel production value.

18. The media of claim 17, wherein the acts comprise:
receiving data indicating to generate two scenarios of the fossil fuel production field;
based on the fourth value of the second constraint and second amount to adjust the second constraint, determining second Lagrange multipliers of the second constraint;
based on the third value of the first constraint and the first amount to adjust the first constraint, determining a second gradient of the first constraint;
based on the second gradient and the second Lagrange multiplier, determining whether adjusting the first constraint from the third value according to the first amount or adjusting the second constraint from the fourth value according to the second amount has a larger impact on fossil fuel production from the fossil fuel production field;
based on determining whether adjusting the first constraint or the second constraint has a larger impact on fossil fuel production from the fossil fuel production field, generating a third scenario of the fossil fuel production field, wherein the third scenario includes a fifth value of the first constraint, a sixth value of the second constraint, and third fossil fuel production value.

19. The media of claim 17, wherein the first scenario further includes a fifth value of a third constraint, and the acts further comprise:
receiving data indicating to group the first constraint and the third constraint;
receiving a third amount to adjust the third constraint; and
based on the fifth value of the third constraint and the third amount to adjust the third constraint, determining a second gradient or Lagrange multipliers of the third constraint,
wherein determining whether adjusting the first constraint from the first value according to the first amount or adjusting the second constraint from the second value according to the second amount has a larger impact on fossil fuel production from the fossil fuel production field comprises:
based on the first gradient, the first Lagrange multiplier, the second gradient or Lagrange multiplier, and the data indicating to group the first constraint and the third constraint, determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, and
wherein generating the second scenario of the fossil fuel production field comprises:
based on determining whether (i) adjusting the first constraint from the first value according to the first amount and adjusting the third constraint from the fifth value according to the third amount or (ii) adjusting the second constraint from the second value according to the second amount has a larger impact on fossil fuel production from the fossil fuel production field, generating the second scenario of the fossil fuel production field, wherein the second scenario includes the third value of the first constraint, the fourth value of the second constraint, a fifth value of the third constraint, and the second fossil fuel production value.

20. The media of claim 17, wherein the first scenario further includes a fifth value of a third constraint and a sixth value of a fourth constraint, and the acts further comprise:
receiving a third amount to adjust the third constraint and a fourth amount to adjust the fourth constraint;
based on the sixth value of the fourth constraint and fourth amount to adjust the fourth constraint, determining second Lagrange multipliers of the third constraint;
based on the fifth value of the third constraint and the third amount to adjust the third constraint, determining a second gradient of the third constraint;
comparing the first gradient to the second gradient; and
comparing the first Lagrange multipliers to the second Lagrange multiplier,
wherein determining whether adjusting the first constraint from the first value according to the first amount or adjusting the second constraint from the second value according to the second amount has a larger impact on fossil fuel production from the fossil fuel production field is based further on comparing the first gradient to the second gradient and comparing the first Lagrange multipliers to the second Lagrange multiplier.
